(19) United States
(12) Patent Application Publication
(10) Pub. No.: US 2024/0351060 A1
(43) Pub. Date: Oct. 24, 2024

(54) A COATING SYSTEM FOR COATING A SUBSTRATE AND A PROCESS OF COATING THE SUBSTRATE WITH THE SAME

(71) Applicant: BASF CORPORATION, Florham Park, NJ (US)

(72) Inventors: Yuting LI, Shanghai (CN); Juncong JIANG, Beijing (CN); Yunfei QI, Shanghai (CN); Chenghao DENG, Shanghai (CN); Jiancheng LIU, Shanghai (CN); Attilio SIANI, Hannover (DE); Xiaomin YIN, Shanghai (CN)

(21) Appl. No.: 18/684,510

(22) PCT Filed: Aug. 18, 2022
(86) PCT No.: PCT/CN2022/113358

§ 371 Date: Feb. 16, 2024

(30) Foreign Application Priority Data
Aug. 19, 2021 (WO) PCT/CN2021/113509

(51) Int. Cl. B05C 5/02; B01J 37/02

(52) U.S. Cl. CPC B05C 5/0225; B01J 37/0221

(57) ABSTRACT

A coating system for coating a substrate, comprising: a dosing unit for pre-weighing and dosing a solid material to be conveyed; a conveying unit for conveying the weighed solid material to the substrate to be coated by a conveying gas flow; a receiving unit for receiving the substrate and located downstream of the conveying unit along a flowing direction of the conveying gas flow; and a control unit for controlling the operation of the dosing unit, the conveying unit and the receiving unit.

### TECHNOLOGY FIELD

The invention relates to a coating system for coating a substrate, in particular a substrate for a wall-flow filter and a process of coating the substrate with the coating system.

### BACKGROUND

Certain internal combustion engines, for example lean-burn engines, diesel engines, natural gas engines, power plants, incinerators, and gasoline engines, tend to produce an exhaust gas with a considerable amount of soot and other particulate matter. Usually, particulate matter emissions can be remedied by passing the PM-containing exhaust gas through a wall-flow filter.

Diesel wall-flow filter have proven to be efficient at removing carbon soot from the exhaust gas of the diesel engines. The most widely used diesel particulate filter is the wall-flow filter which filters the diesel exhaust gas by capturing the soot on the porous walls of the filter body. The wall-flow filter is designed to provide for nearly complete filtration of soot without significantly hindering the exhaust flow.

There is a need to provide an improved coating system and coating process to obtain a filter, e.g., a wall-flow filter having excellent filtration efficiency and low backpressure.

Lately, even stricter regulations like Euro 6d and China 6b were imposed, and the conventional catalytic filter technology was not able to simultaneously meet the customer's emission targets for particulate matter & backpressure targets for exhaust system without further improvement. This created an urgent need for developing the next generation catalytic filter (or FWC) and at the same time a new coating system to be able to produce this next generation product in large scale.

### SUMMARY OF THE INVENTION

An object of the present invention is to provide an improved coating system for more efficiently preparing a filter having excellent filtration efficiency and low backpressure.

Another object of the present invention is to provide an improved coating process for more efficiently preparing a filter having excellent filtration efficiency and low backpressure.

So, one aspect of the present invention relates to a coating system for coating a substrate, comprising: a dosing unit for pre-weighing and dosing a solid material to be conveyed; a conveying unit for conveying the weighed solid material to the substrate to be coated by a conveying gas flow; a receiving unit for receiving the substrate and located downstream of the conveying unit along a flowing direction of the conveying gas flow; a control unit for controlling the operation of the dosing unit, the conveying unit and the receiving unit. In an embodiment, the dosing unit may comprise an automatic material dosing device having a material container with a dispensing port and a dispensing mechanism arranged in the material container; a material transfer container; and a weighing device; wherein the dispensing mechanism is used for dispensing the solid material into the material transfer container through the dispensing port, and the weighing device is used for weighing the solid material in the material transfer container.

In an embodiment, the dispensing mechanism and the weighing device may be respectively in communication with the control unit, and the control unit receives a weight measurement value of the solid material dispensing into the material transfer container from the weighing device, and compares the weight measurement value with the set weight of the solid material to be conveyed, and the control unit will control the dispensing mechanism to stop dispensing the solid material, if the weight measurement value is in the range of the set weight±5%.

In an embodiment, the conveying unit may comprise a conveying pipe having an inlet end and an outlet end, wherein a first check valve and a second check valve are provided between the inlet end and the outlet end; a fan for generating a conveying gas flow flowing from the outlet end of the conveying pipe to the receiving unit; and a connecting pipeline fluidly communicating the fan with the outlet end of the conveying pipe and the receiving unit.

Preferably, the conveying pipe may be vertically arranged, and its inlet end is of funnel-shaped, and the conveying unit may further comprise a gas buffer box arranged between the fan and the conveying pipe; a cooler arranged between the fan and the gas buffer box; a first control valve provided between the cooler and the gas buffer tank; a second control valve provided between the gas buffer box and the conveying pipe; and a branch pipe provided between the cooler and the first control valve, which fluidly communicating the connecting pipeline with the external environment, and a third control valve is disposed in the branch pipe.

In an embodiment, the receiving unit may comprise a holding mechanism for fixedly holding the substrate, the holding mechanism is airtightly connected to the fan by means of the connecting pipeline.

Preferably, the holding mechanism is an inflatable flexible holder which can be adjusted to hold the substrates of different sizes.

In an embodiment, the connecting pipeline may comprise a first pipe section connected to the fan and the outlet end of the conveying pipe and having a first cross section, and a second tapered pipe section connected to the receiving unit, the minimum cross section of the second tapered pipe section is equal to the first cross section, and the maximum cross section of the second tapered pipe section is defined as a second cross section which is greater than or equal to the cross section of the substrate.

In an embodiment, the diameter of the first cross-section may be in the range of 0.3D-0.75D, preferably 0.4D-0.6D. The maximum diameter of the second cross-section may be in the range of 1D-1.2D, preferably 1.02D-1.1D. The height of the second tapered pipe section may be in the range of 0.3D-0.9D, preferably 0.4D-0.8D, wherein D means the diameter of the circular cross-section of the substrate or the minor axis of the elliptical cross-section of the substrate in case the substrate is an elliptical cylinder.

A person skilled in the art can understand that a circular cylinder has a circular cross-section and an elliptical cylinder has an elliptical cross-section.

In an embodiment, in case D of the substrate is in the range of 95 mm-155 mm, the diameter of the first cross-section may be in the range of 60 mm-100 mm, for example 60 mm or 100 mm, the maximum diameter of the second cross-section may be in the range of 96 to 160 mm, for example 98 or 155 mm, and the height of the second tapered pipe section may be in the range of 60 mm-130 mm.

In another embodiment, the connecting pipeline may comprise a first pipe section connected to the fan and the outlet end of the conveying pipe and having a first cross section, a second tapered pipe section connected to the receiving unit, and a third pipe section connecting the first pipe section and the second tapered pipe section, the third pipe section is connected to the first pipe section by a tapered connecting portion thereof, the maximum cross section of the second tapered pipe section is defined as a second cross section, the second cross section is greater than or equal to the cross section of the substrate, and the cross section of the third pipe section is defined as a third cross section, wherein the third cross section is greater than the first cross section and equal to the minimum cross section of the second tapered pipe section.

In an embodiment, the substrate may be a filter substrate, in particular a wall-flow filter substrate having an inlet side and an outlet side, and the substrate is arranged in the inflatable flexible holder with its inlet side facing the conveying unit.

Preferably, the coating system according to the present invention may further comprise an automatic transfer mechanism for transferring the substrate to be coated to the receiving unit and removing the coated substrate from the receiving unit.

The present invention also relates to a process of coating a substrate with the above coating system, the process may comprise the steps of: providing the substrate; fixedly holding the substrate in a receiving unit; pre-weighing a solid material to be coated on the substrate by a dosing unit; mixing the weighed solid material with the conveying gas flow and convey them to the receiving unit by the conveying unit to coat the substrate; and removing the coated substrate from the receiving unit.

In the above process, the substrate may be a substrate for a wall-flow filter.

The coating system according to the present invention is able to simultaneously meet the customer's emission targets for particulate matter & backpressure targets for exhaust system without further improvement. The product (catalytic filter) obtained by this new coating system has a higher trapping efficiency for particulate matter, and at the same time the coating system is able to produce this product in large scale.

### DESCRIPTION OF THE DRAWING

FIG. 1 shows a schematic block diagram of one embodiment of a coating system according to the present invention

FIG. 2 shows a schematic structural diagram of the dosing unit according to the present invention.

FIG. 3 is a schematic structural diagram shows the conveying unit and the receiving unit connected with each other.

FIG. 4 is a schematic structural diagram shows the conveying pipe and the connecting pipeline connected to each other.

FIG. 5 is a schematic structural diagram shows an embodiment of a connecting section for connecting the conveying pipe to the receiving unit according to the present invention.

FIG. 6 is a schematic structural diagram shows another embodiment of a connecting section for connecting the conveying pipe to the receiving unit according to the present invention.

FIG. 7 is a schematic structural diagram shows an embodiment of the substrate for wall-flow filter according to the present invention.

### DETAILED DESCRIPTION OF THE EMBODIMENTS

The undefined article “a”, “an”, “the” means one or more of the species designated by the term following said article.

In the context of the present disclosure, any specific values mentioned for a feature (comprising the specific values mentioned in a range as the end point) can be recombined to form a new range.

In the context of the present disclosure, each aspect so defined may be combined with any other aspect or aspects unless clearly indicated to the contrary. In particular, any feature indicated as being preferred or advantageous may be combined with any other feature or features indicated as being preferred or advantageous.

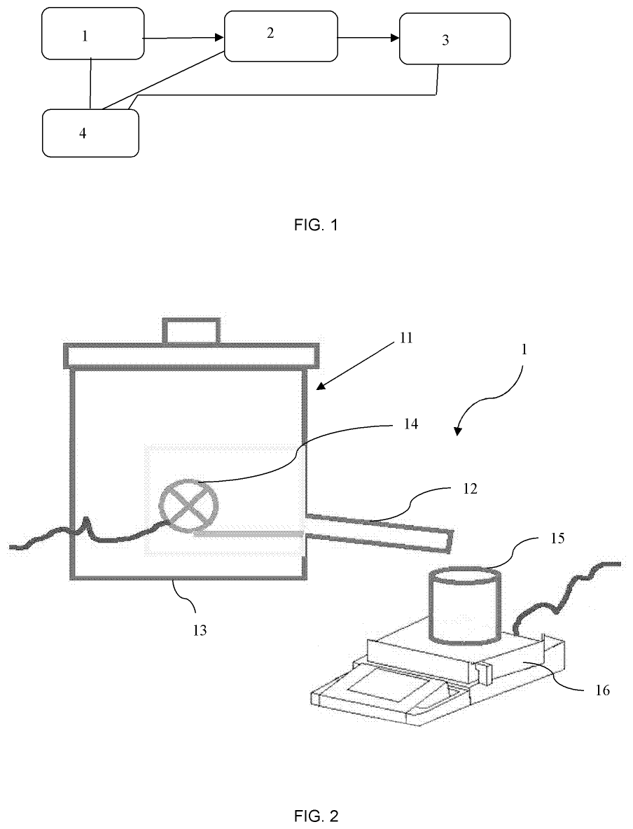

FIG. 1 shows a schematic block diagram of one embodiment of a coating system for coating a substrate 10 according to the present invention. The coating system mainly comprises a dosing unit 1, a conveying unit 2, a receiving unit 3, and a control unit 4 for controlling the operation of the dosing unit 1, the conveying unit 2 and the receiving unit 3. The dosing unit 1 is used for pre-weighing and dosing a solid material to be conveyed, and the conveying unit 2 is used for conveying the weighed solid material to the substrate 10 to be coated by a conveying gas flow. In addition, the receiving unit 3 is used for receiving the substrate and located downstream of the conveying unit along a flowing direction F of the conveying gas flow. In this invention, the substrate may be a substrate for particulate filters, in particular a wall-flow filter. However, one skilled in the art should be understood that the substrate may also be other types of substrates that need to be coated.

In a preferred embodiment, as shown in FIG. 2, the dosing unit 1 may comprise an automatic material dosing device 11, a material transfer container 15 and a weighing device 16. It can be seen from the figure that the automatic material dosing device 11 is configured to include a material container 13 with a dispensing port (or a dispensing tube) 12 and a dispensing mechanism 14 arranged in the material container. The solid materials to be conveyed are contained in the material container, and the dispensing mechanism 14 is used for dispensing the solid material into the material transfer container 15 such as a cup through the dispensing port 12, and the solid material in the material transfer container is weighed by the weighing device. In an example, the dispensing mechanism 14 may be, for example, a threaded screw mechanism for pushing solid materials into the dispensing pipe which is arranged obliquely.

In the above dosing unit 1, the dispensing mechanism 14 and the weighing device 16 are respectively in communication with the control unit 4, and the control unit 4 receives a weight measurement value W1 of the solid material dispensing into the material transfer container from the weighing device 16, and compares the weight measurement value W1 with the set weight W of the solid material to be conveyed, and the control unit 4 will control the dispensing mechanism 14 to stop dispensing the solid material, if the weight measurement value W1 is in the range of the set weight W±5%.

In actual operation, the weight measurement value W1 of the solid material is the weight measurement value Wt of the weighing device 16 subtract the weight Wc of the material transfer container 15. Since it is difficult to avoid adhering some solid materials to the wall of the material transfer container 15, after feeding the solid materials in the material transfer container 15 into the conveying unit 2, it is necessary to put the empty material transfer container 15 on the weighing device 16 for re-weighing, and the measured value is Wr, then Wt−Wr is the actual material weight G feeding into the conveying unit 2. If the actual material weight G is within the specified range, for example, in the range of the set weight W±5%, the dosing unit 1 will continue to weigh the solid material for the next substrate, otherwise, the weighing device 16 will send a signal to the control unit to mark the substrate coated in this time as a “reject product”.

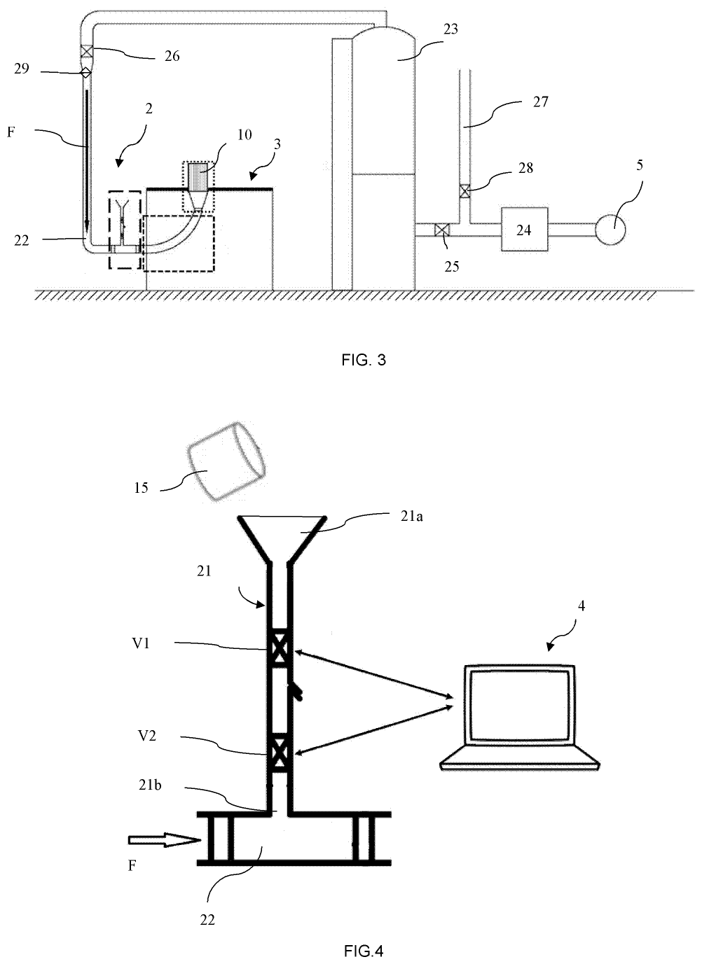

In an embodiment according to the present invention, as shown in FIG. 3, the conveying unit 2 may comprise a fan 5, a conveying pipe 21 and a connecting pipeline 22 fluidly communicating the fan 5 with the outlet end 21b of the conveying pipe and the receiving unit 3.

Referring to FIG. 4 particularly, the conveying pipe 21, having an inlet end 21a and an outlet end 21b, is vertically arranged and its inlet end 21a is preferably of funnel shaped. A first check valve (i.e., one-way valve) V1 and a second check valve V2 may be provided between the inlet end and the outlet end in the conveying pipe 21, and the first check valve V1 and the second check valve V2 are respectively in communication with the control unit 4, and the opening and closing of these valves are controlled by the control unit 4. For example, the first check valve V1 at the upper part of the conveying pipe 21 can be opened firstly, and the solid materials may be fed into the conveying pipe 2 from the material transfer container 15, then the first check valve V1 is closed, and finally the second check valve V2 is opened. Under the action of gravity, the solid materials will be conveyed into the conveying pipeline 22 and conveyed to the receiving unit 3 by the conveying air flow from the fan 5. The main purpose of providing two check valves is to prevent the solid materials from being blown out by the conveying air flow from the fan 5 in the reverse direction when the solid materials are fed into the conveying pipe 21, resulting in the loss of the solid materials.

Referring to FIG. 3 again, in order to maintain the stability of the conveying air flow, the conveying unit 2 further comprises a gas buffer box 23 arranged between the fan 5 and the conveying pipe 21. To prevent the fan from overheating, a cooler 24 is provided between the fan 5 and the gas buffer tank 2. In addition, a first control valve 25 is provided between the cooler 24 and the gas buffer box 23, and a second control valve 26 is provided between the gas buffer box 23 and the conveying pipe 21 for controlling the speed of the conveying gas flow. Moreover, a branch pipe 27 which can fluidly communicate the connecting pipe 22 with the external environment may be further arranged between the first control valve 25 and the cooler 24, and a third control valve 28 is arranged in the branch pipe 27, and the third control valve 28 may be fully or partially opened when the coating system works, so as to control the flow rate of the conveying air flow in the conveying unit 2. In order to control the stability of the coating process, a flow sensor 29 may also be provided downstream of the second control valve 26 in the connecting pipe 22 to monitor the flow rate of the conveying air stream.

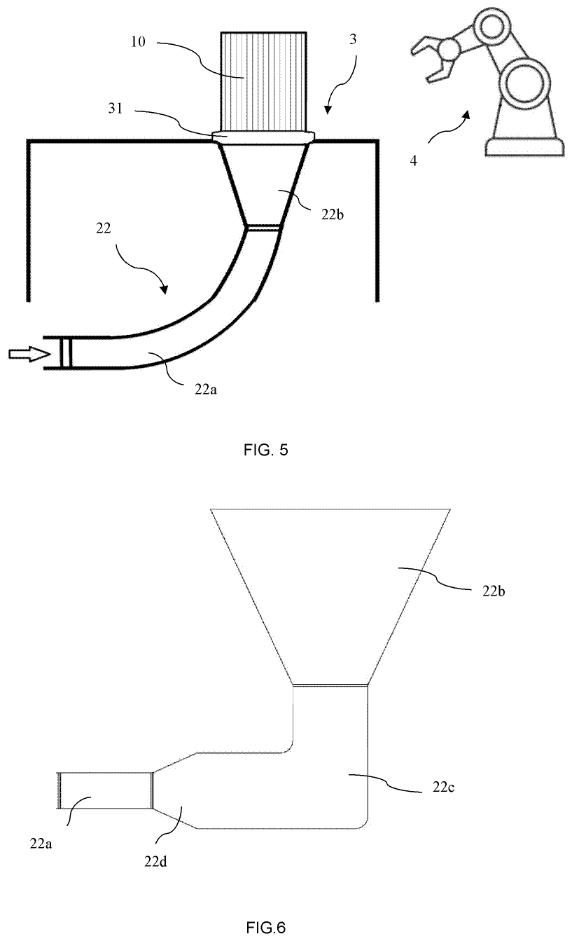

According to an embodiment of the present invention, as shown in FIG. 5, the receiving unit 3 may comprise a holding mechanism 31 for fixedly holding the substrate 10 to be coated, and the holding mechanism may be airtightly connected to the fan 5 by means of a connecting pipe 22. Advantageously, the holding mechanism 31 is an inflatable flexible holder which can be adjusted to accommodate substrates 10 of different sizes. For example, the inflatable flexible holder may be in the form of a swimming ring or a tire.

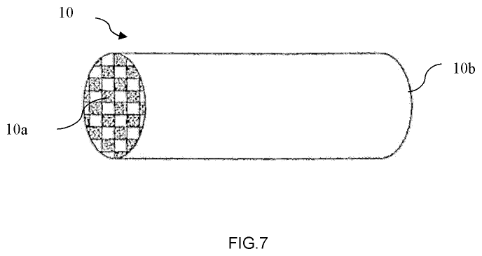

In the present invention, referring to FIG. 7, the substrate 10 is, for example, a wall-flow filtered substrate, and has an inlet side 10a and an outlet side 10b, wherein the substrate 10 is arranged in the inflatable flexible holder with its inlet side 10a facing the conveying unit 2, in other words, with its inlet side 10a facing the connecting pipe 22. The substrate shown in this figure has a circular cross section, and the diameter (D) of the cross-section of the substrate with relatively small size may be in the range of 95 mm-155 mm, while the diameter (D) of the cross-section of the substrate with relatively large size may be in the range of 160 mm-350 mm, for example.

In an embodiment not shown, the cross-section of the substrate may be elliptical, in which case, the minor axis (D) of the elliptical cross-section of the substrate with relatively small size may be in the range of 95 mm-155 mm, while the minor axis (D) of the cross-section of the substrate with relatively large size may be in the range of 160 mm-350 mm.

Referring to FIG. 5 again, which is a schematic structural diagram shows an embodiment of a connecting section of the connecting pipeline 22 for connecting the conveying pipe 21 to the receiving unit 3 according to the present invention.

As can be seen in FIG. 3 and FIG. 5, the connecting pipeline 22 comprises a first pipe section 22a connected to the fan 5 and the outlet end 21b of the conveying pipe and having a first cross section, and a second tapered pipe section 22b connected to the receiving unit 3, the minimum cross section of the second tapered pipe section is equal to the first cross section, and the maximum cross section of the second tapered pipe section is defined as a second cross section which is greater than or equal to the cross section of the substrate 10.

The configuration of said connecting section of the connecting pipeline, shown in FIG. 5, is especially suitable for substrates with small size, for example, the diameter/minor axis (D) of the cross section of the substrate 10 is in the range of 95 mm-155 mm. In this case, the diameter of the first cross section may be in the range of 0.3D-0.75D, preferably 0.4D-0.6D, for example 60 mm-100 mm, the maximum diameter of the second cross section may be in the range of 1D-1.2D, preferably 1.02D-1.1D, for example 95-155 mm, and the height of the second tapered pipe section 22b may be in the range of 0.3D-0.9D, preferably 0.4D-0.8D, for example 60 mm-130 mm.

FIG. 6 is a schematic structural diagram shows another embodiment of a connecting section of the connecting pipeline 22 for connecting the conveying pipe 21 to the receiving unit 3 according to the present invention. The configuration of said connecting section of the connecting pipeline, shown in FIG. 6, is especially suitable for substrates with larger size, for example, the diameter/minor axis (D) of the cross section of the substrate is in the range of 160 mm-350 mm.

In this embodiment, the connecting pipeline 22 comprises a first pipe section 22a connected to the fan 5 and the outlet end 21b of the conveying pipe 21 and having a first cross section, a second tapered pipe section 22b connected to the receiving unit 3, and a third pipe section 22c connecting the first pipe section 22a with the second tapered pipe section 22b, the third pipe section is connected to the first pipe section 22b by a tapered connecting portion 22d thereof, the maximum cross section of the second tapered pipe section is defined as a second cross section, the second cross section is greater than or equal to the cross section of the substrate 10, and the cross section of the third pipe section is defined as a third cross section, wherein the third cross section is greater than the first cross section and equal to the minimum cross section of the second tapered pipe section. For example, in one example, the diameter of the first cross section may be 0.17D-0.375 D, the diameter of the third cross section may be 0.28D-0.625 D, and the diameter of the second cross section may be greater than or equal to D. Specifically, the diameter of the first cross section may be 60 mm, the diameter of the third cross section may be 100 mm, and the diameter of the second cross section may be 350 mm.

Further referring to FIG. 5, the coating system according to the present invention may further comprise an automatic transfer mechanism 6 for transferring the substrate 10 to be coated to the receiving unit and removing the coated substrate from the receiving unit. Herein, the automatic transfer mechanism 6 may be a robot.

The present invention also relates to a process of coating a substrate 10 with the above-mentioned coating system to obtain a product such a wall-flow filter, the process comprises the steps of: providing the substrate 10; fixedly holding the substrate in a receiving unit 3; pre-weighing a solid material to be coated on the substrate by a dosing unit 1; mixing the weighed solid material with the conveying gas flow and convey them to the receiving unit 3 by the conveying unit 2 to coat the substrate; and removing the coated substrate from the receiving unit 3.

In the step of providing the substrate 10, a scanning device (not shown in the figure) can be provided to scan the provided substrate to judge whether the batch of the substrate is correct. If it is correct, the substrate will be fixed and held in the receiving unit 3, otherwise, the substrate will be judged as a reject substrate.

In the step of pre-weighing a solid material to be coated on the substrate by a dosing unit 1, the weight G of the solid materials, which are actually fed into the conveying unit 2, can also be measured by the weighing device 16 and sent to the control unit for comparing with the set weight W. If G is within the range of the set weight W±5%, the metering unit will continue to weigh the solid materials for the next substrate, otherwise it will send a signal to the control unit to mark the coated substrate as a rejected product.

In the step of mixing the weighed solid material with the conveying gas flow and convey them to the receiving unit 3 to coat the substrate by the conveying unit 2, the flow rate of the conveying gas flow can be controlled by the first control valve, the second control valve and the third control valve.

In order to make the obtained products with the qualified product characteristics and appearance, the conveying gas flow with different flow rates can be provided for substrates with different sizes. For example, for the substrate with a cross-sectional diameter or minor axis below 100 mm, the flow rate of the conveying air flow can be selected as 600±40 m³/h; for the substrate with a cross-sectional diameter or minor axis in the range of 100 mm-160 mm, the flow rate of the conveying air flow can be selected to be in the range of 300 m³/h-800 m³/h. Meanwhile, for the substrates with larger size, the flow rate of the conveying air flow can be selected to be in the range of 500 m³/h-1000 m³/h. In addition, during coating, it is necessary to use a conveying gas flow with a suitable flow rate to purge the substrate to be coated for a certain period of time, such as 20 seconds. If the flow rate is not suitable and the purging time is not enough, the obtained product may be unqualified.

After the step of removing the coated substrate from the receiving unit 3, it is possible to judge whether the obtained product is qualified by a backpressure test. For example, if the backpressure of the desired product is P and the measured backpressure Pt=P (1±5%), the product can be judged as a qualified product, otherwise it can be judged as a unqualified product (reject product).

Various modifications and variations conceivable by those skilled in the art can be made to the embodiments disclosed above without departing from the scope or spirit of the present disclosure. According to the disclosure, other embodiments will be obvious to those skilled in the art. This description and its disclosed examples are to be considered illustrative only, and the protection scope of the present disclosure is to be specified by the appended claims and their equivalents.

1. A coating system for coating a substrate, comprising:
a dosing unit for pre-weighing and dosing a solid material to be conveyed;
a conveying unit for conveying the weighed solid material to the substrate to be coated by a conveying gas flow;
a receiving unit for receiving the substrate and located downstream of the conveying unit along a flowing direction of the conveying gas flow; and
a control unit for controlling the operation of the dosing unit, the conveying unit and the receiving unit.

2. The coating system according to claim 1, wherein the dosing unit comprises:
an automatic material dosing device comprising a material container with a dispensing port and a dispensing mechanism arranged in the material container;
a material transfer container; and,
a weighing device;
wherein the dispensing mechanism is used for dispensing the solid material into the material transfer container through the dispensing port, and the weighing device is used for weighing the solid material in the material transfer container.

3. The coating system according to claim 2, wherein, the dispensing mechanism and the weighing device are respectively in communication with the control unit, and the control unit receives a weight measurement value of the solid material dispensing into the material transfer container from the weighing device, and compares the weight measurement value with the set weight of the solid material to be conveyed, and the control unit will control the dispensing mechanism to stop dispensing the solid material, if the weight measurement value is equal to the set weight.

4. The coating system according to claim 1, wherein, the conveying unit comprises:
a conveying pipe having an inlet end and an outlet end, wherein a first check valve and a second check valve are provided between the inlet end and the outlet end;
a fan for generating a conveying gas flow flowing from the outlet end of the conveying pipe to the receiving unit; and,
a connecting pipeline fluidly communicating the fan with the outlet end of the conveying pipe and the receiving unit.

5. The coating system according to claim 4, wherein the conveying pipe is vertically arranged and its inlet end is of funnel-shaped, and the conveying unit further comprises:
a gas buffer box arranged between the fan and the conveying pipe;
a cooler arranged between the fan and the gas buffer box;
a first control valve provided between the cooler and the gas buffer tank;
a second control valve provided between the gas buffer box and the conveying pipe; and
a branch pipe provided between the cooler and the first control valve, which fluidly communicating the connecting pipeline with the external environment, and a third control valve is disposed in the branch pipe.

6. The coating system according to claim 4, wherein the receiving unit comprises:
a holding mechanism for fixedly holding the substrate, the holding mechanism is airtightly connected to the fan by means of the connecting pipeline.

7. The coating system according to claim 6, wherein the holding mechanism is an inflatable flexible holder which can be adjusted to hold the substrates of different sizes.

8. The coating system according to claim 7, wherein the connecting pipeline comprises a first pipe section connected to the fan and the outlet end of the conveying pipe and having a first cross section, and a second tapered pipe section connected to the receiving unit, the minimum cross section of the second tapered pipe section is equal to the first cross section, and the maximum cross section of the second tapered pipe section is defined as a second cross section which is greater than or equal to the cross section of the substrate.

9. The coating system according to claim 8, wherein the diameter of the first cross section is in the range of 0.3D-0.75D, preferably 0.4D-0.6D; the maximum diameter of the second cross section is in the range of 1 D-1.2D, preferably 1.02D-1.1 D, and the height of the second tapered pipe section 22b is in the range of 0.3D-0.9D, preferably 0.4D-0.8D, wherein D means the diameter of the circular cross-section of the substrate or the minor axis of the elliptical cross-section of the substrate in case the substrate is an elliptic cylinder.

10. The coating system according to claim 7, wherein the connecting pipeline comprises a first pipe section connected to the fan and the outlet end of the conveying pipe and having a first cross section, a second tapered pipe section connected to the receiving unit, and a third pipe section connecting the first pipe section with the second tapered pipe section, the third pipe section is connected to the first pipe section by a tapered connecting portion thereof, the maximum cross section of the second tapered pipe section is defined as a second cross section, the second cross section is greater than or equal to the cross section of the substrate, and the cross section of the third pipe section is defined as a third cross section, wherein the third cross section is greater than the first cross section and equal to the minimum cross section of the second tapered pipe section.

11. The coating system according to claim 6, wherein the substrate is a substrate for a wall-flow filter and has an inlet side and an outlet side, and the substrate is arranged in the inflatable flexible holder with its inlet side facing the conveying unit.

12. The coating system according to claim 1, further comprising:
an automatic transfer mechanism for transferring the substrate to be coated to the receiving unit and removing the coated substrate from the receiving unit.

13. A process of coating a substrate with the coating system according to claim 1, comprising:
providing the substrate;
fixedly holding the substrate in a receiving unit;
pre-weighing a solid material to be coated on the substrate by a dosing unit;
mixing the weighed solid material with the conveying gas flow and convey them to the receiving unit by the conveying unit to coat the substrate; and,
removing the coated substrate from the receiving unit.

14. The process according to claim 13, wherein the substrate is a substrate for a wall-flow filter.
